(19) United States
(12) Patent Application Publication
(10) Pub. No.: US 2018/0106956 A1
(43) Pub. Date: Apr. 19, 2018

(54) BACKLIGHT MODULE WITH MEMBRANE SWITCH FUNCTION

(71) Applicant: CHICONY POWER TECHNOLOGY CO., LTD., New Taipei City (TW)

(72) Inventor: Pai-Hsiang WANG, New Taipei City (TW)

(21) Appl. No.: 15/293,948

(22) Filed: Oct. 14, 2016

(51) Int. Cl. F21V 8/00; G06F 3/02

(52) U.S. Cl. CPC G02B 6/0083; G02B 6/0055; G06F 3/0202; G02B 6/0065; G02B 6/0068

(57) ABSTRACT

A backlight module includes a reflective film, a light guide plate located on the top side of the reflective film and defining a light incident area, a light-shielding film located on the light guide plate opposite to the reflective film, a membrane switch structure including a first circuit layer mounted on the reflective film and disposed between the light guide plate and the reflective film and a second circuit layer mounted on the light-shielding film to face toward the light guide plate, and a light source disposed adjacent to the light guide plate with light-emitting elements arranged for emitting light toward the light incident area of the light guide.

### BACKGROUND OF THE INVENTION

### 1. Field of the Invention

The present invention relates to backlight technology and more particularly, to a backlight module with membrane switch function, which has the first circuit layer of the bottom layer of the membrane switch arranged on a reflective film of a reflective layer, the second circuit layer of the top layer of the membrane switch arranged on a light-shielding film and a light guide plate with through holes set between the first circuit layer and the second circuit layer for use as a spacer layer that creates vertical spacing between the first circuit layer and the second circuit layer, thus, the backlight module has the characteristics of simple structure and low profile.

### 2. Description of the Related Art

With fast development of electronic technology and information industry, many different kinds of electrical and electronic products with light, thin, short and small characteristics such as computer, notebook, mobile Internet device (MID), smart phone, tablet computer, etc. have been continuously created and widely used in our daily life, bringing comfort and convenience to people and improving the standard of living of the people. For communication between a user and an electronic product, a mouse, keyboard or any other input device is normally used. Among the various input devices, keyboard is most convenient for a user to input text, numerals or instructions.

Further, in order for enabling a user to clearly identify the signs on the key cap of each key switch, backlit keyboards are created. A backlit keyboard has a backlight module with light guide plate and light source means mounted therein so that when the user presses the key cap of key switch, the light emitted by the backlight module is projected onto the back side of the key cap, enabling the user to clearly identify the signs on the key cap.

A commercial backlit keyboard generally comprises a key switch module and a backlight module. The backlight module comprises a light guide plate, a light source mounted on one lateral side of the light guide plate and comprising a flexible circuit board and a plurality of light-emitting diodes mounted on the flexible circuit board for emitting light into the light guide plate, a plate reflector mounted on the bottom surface of the light guide plate for reflecting light back into the inside of the light guide plate, and a light-shielding film mounted on the opposing top surface of the light guide plate. The light-shielding film has light transmissive portions corresponding to the key switches of the key switch module so that the light emitted by the light source can be guided by the light guide plate through each light transmissive portion of the light-shielding film toward the key cap of the respective key switch that is pressed by the user.

The key switch module comprises a bottom plate, a plurality of key switch units, a membrane circuit board and at least one elastic member. The key switch units are mounted on the bottom plate, each comprising a key cap and a linking mechanism coupled between the key cap and the bottom plate and movable up and down. The elastic member is mounted between the membrane circuit board and the multiple key switch units. When the user presses the key cap of one key switch unit, the elastic member will be forced by the key cap to touch the membrane circuit board, causing the membrane circuit board to provide a corresponding trigger signal to the controller of the backlit keyboard. The membrane circuit board comprises a top circuit layer, a bottom circuit layer, and an intermediate spacer layer set between the top circuit layer and the bottom circuit layer. The intermediate spacer layer has through holes. When the key cap of one key switch unit is pressed by the user to touch the membrane circuit board, the top circuit layer of the membrane circuit board is compressed and partially forced through one respective through hole of the intermediate spacer layer into contact with the bottom circuit layer to generate a corresponding trigger signal and to provide the generated trigger signal to the controller of the backlit keyboard, achieving the input of a text, numeral or instruction.

Since backlit keyboard has been developed intensively for decades, the backlit keyboard technology has been very mature. Under the current situation that the internal structures of commercial backlit keyboards have been well simplified, unless it is developed a total new structure with a thin-thickness lightweight circuit board of fine circuits, it is difficult to make enormous structural changes on backlit keyboard design. Therefore, when the general structure cannot be changed, it is the normal way to make changes on the detailed structure of the backlit keyboard so as to reduce the overall backlit keyboard thickness and to better meet the light, thin, short, small design requirements. Further, in actual application, the assembly process and device manufacturing costs also need to be taken into account. In the aforesaid prior art backlight module, the flexible circuit board and light-emitting diodes of the light source are mounted on one lateral side of the light guide plate, the plate reflector and the light-shielding film are arranged on the opposing top and bottom surface of the light guide plate to constitute a stacked structure that is assembled with the bottom plate, key switch units, membrane circuit board and at least one elastic member of the key switch module to constitute a multi-layer structure. This multi-layer structure has a certain thickness and complicates the manufacturing process. Further, the plate reflector needs to provide through holes for receiving the light-emitting diodes of the light source so that the light-emitting diodes can emit light onto the light guide plate. The formation of these through holes on the plate reflector relatively complicates the manufacturing process and increases the manufacturing costs. Therefore, there is room for improvement in the design of backlit keyboard.

### SUMMARY OF THE INVENTION

The present invention has been accomplished under the circumstances in view. It is therefore the main object of the present invention to provide a backlight module with membrane switch function, which comprises a reflective film, a light guide plate located on the top side of the reflective film and defining a light incident area, a light-shielding film located on the light guide plate opposite to the reflective film, a membrane switch structure including a first circuit layer mounted on the reflective film and disposed between the light guide plate and the reflective film and a second circuit layer mounted on the light-shielding film to face toward the light guide plate, and a light source disposed adjacent to the light guide plate with light-emitting elements arranged for emitting light toward the light incident area of the light guide. The structural design of the reflective film eliminates the use of a reflector seen in the prior art backlight modules, and allows the bottom circuit layer of the membrane switch to be directly made on the reflective film. Further, because the LED power circuit of the at least one light-emitting element of the light source is integrated into the first circuit layer, no any additional flexible circuit board is required for the installation of the at least one light-emitting element of the light source, and thus, the number of layers of the backlight module can be minimized, simplifying the structure, significantly reducing the module thickness for low profile application, effectively shortening the assembly process and reducing the manufacturing cost. Further, because the number of through holes on the reflective film is minimized, the available surface area of the first circuit layer for utilization is maximized. Further, the mounting location of the at least one light-emitting element of the light source on the reflective film can be changed to meet different application requirements without space limitations. Further the amount of the at least one light-emitting element can be changed subject to the dimension or amount of the light guide plate, enhancing the uniform luminous effects of the backlight module.

Further, first electrode contacts and at least one set of positive and negative conducting contacts and power contact of the first circuit layer are created on the surface of the reflective layer of the reflective film, and the at least one light-emitting element of the light source is electrically bonded to the at least one set of positive and negative conducting contacts on the first circuit layer of the reflective film using surface mount technology. Further, the bottom layer of the membrane switch and the LED circuit of the at least one light-emitting element of the light source can be made on the same surface of the first circuit layer according to customer's specification or requirements. Alternatively, the the bottom layer of the membrane switch and the LED circuit of the at least one light-emitting element of the light source can be respectively made on the two opposite surfaces of the reflective film. Further, the light guide plate is set between the reflective film and the light-shielding film for conducting and guiding light. Further, the through holes of the light guide plate are used as a spacer layer to create vertical spacing between the first electrode contacts of the first circuit layer of the bottom layer of the membrane switch and the second electrode contacts of the second circuit layer of the top layer of the membrane switch.

The backlight module further comprises a key switch structure arranged on the light-shielding film. The key switch structure comprises a bottom plate, a plurality of key switch units mounted on the light-shielding film, and at least one elastic member mounted between the key switch units and the light-shielding film. Each key switch unit comprises a key cap spaced above the light-shielding film, and a linking mechanism coupled between the key cap and the bottom plate for enabling the key cap to be alternatively moved up and down so that the elastic member and the light-shielding film are elastically deformed to force the second circuit layer into contact with the first circuit layer to conduct electricity and to provide a corresponding trigger signal to the controller of the backlit keyboard when the key cap is pressed by an external force to move the linking mechanism. Further, when the at least one light-emitting element of the light source is driven to emit light toward the light incident area of the light guide plate, the incident light is distributed in the light guide plate and guided by the light guide plate and reflected by the reflective layer of the reflective film through the light transmissive area of the light-shielding film toward the key switch units of the key switch structure for illumination.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a backlight module with membrane switch function in accordance with a first embodiment of the present invention.

FIG. 2 is an exploded view of the backlight module with membrane switch function in accordance with the first embodiment of the present invention.

FIG. 3 is a sectional view taken along line A-A of FIG. 1.

FIG. 4 is a sectional view taken along line B-B of FIG. 1.

FIG. 5 is an enlarged view of Part X of FIG. 4.

FIG. 6 is an exploded view of a backlight module with membrane switch function in accordance with a second embodiment of the present invention.

FIG. 7 is a sectional side view of the backlight module with membrane switch function in accordance with the second embodiment of the present invention.

FIG. 8 is an enlarged view of Part Y of FIG. 7.

### DETAILED DESCRIPTION OF THE PREFERRED EMBODIMENT

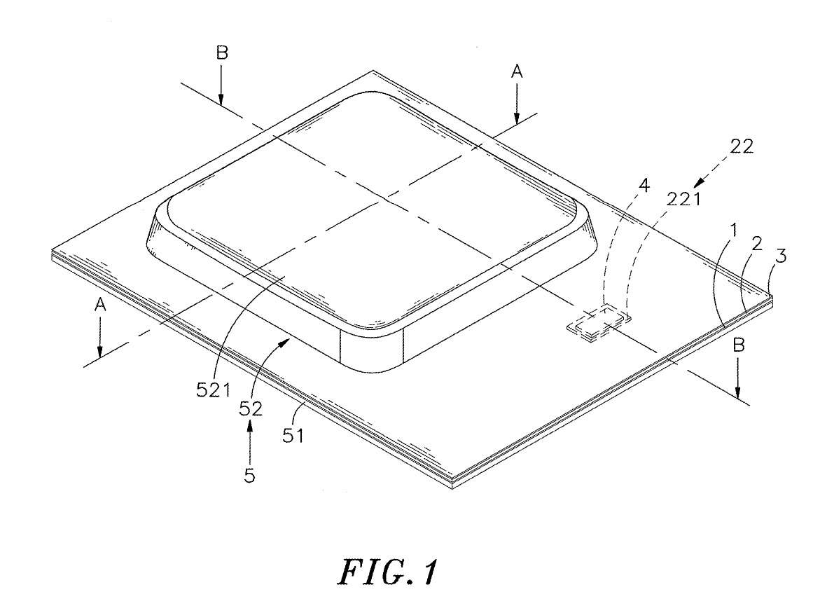

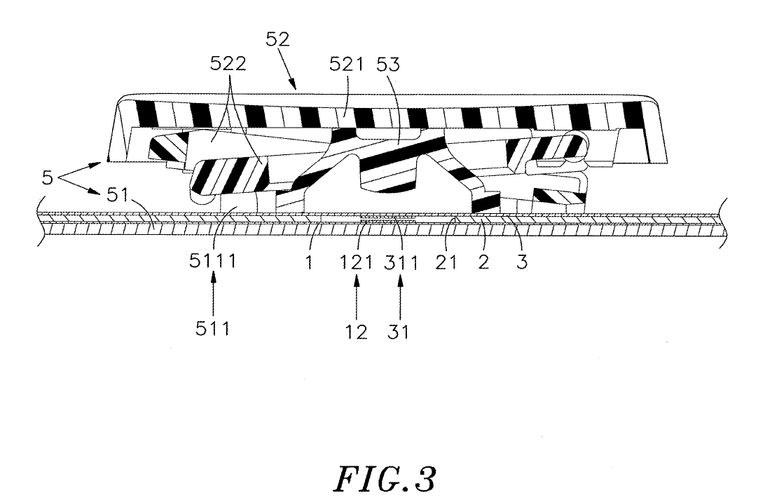

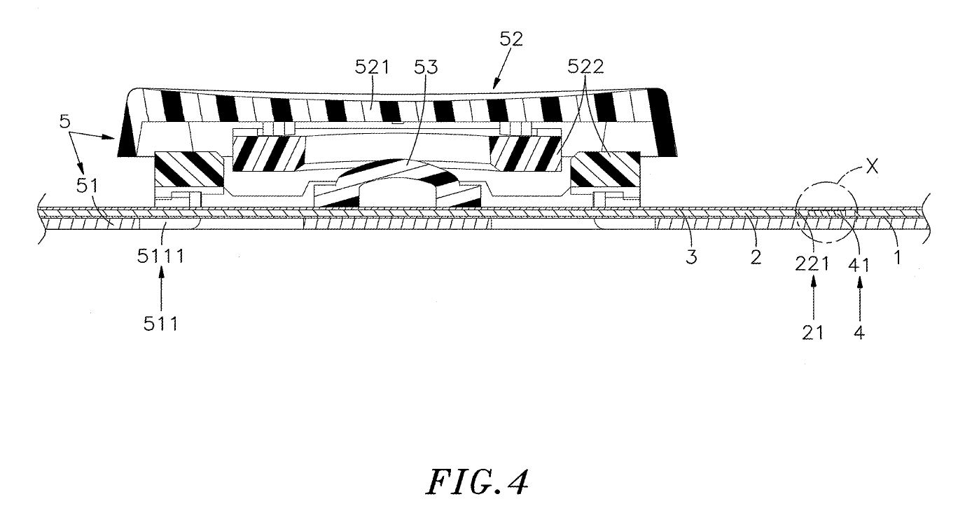

Referring to FIGS. 1-5, a backlight module with membrane switch function in accordance with a first embodiment of the present invention is shown. The backlight module comprises a reflective film 1, a light guide plate 2, a light-shielding film 3, and a light source 4 adapted for emitting light toward the light guide plate 2 for enabling emitted light to be evenly distributed on the light guide plate 2.

The reflective film 1 is a single layer insulative film made from polycarbonate (PC), polyethylene terephthalate (PET), Mylar, or any other suitable flexible material, having one surface thereof (for example, top surface) coated with a layer of white highly reflective ink or other reflective coating by means of paint coating, printing or any other processing method to create a reflective layer 11 having low transmittance and high reflectance characteristic. Further, printing, etching and electroplating manufacturing processes are employed to create a first circuit layer 12 on the surface of the reflective layer 11. The first circuit layer 12 has a circuit layout thereon, and a plurality of first electrode contacts 121 and at least one set of positive and negative conducting contacts 122 and power contact (not shown) arranged on the circuit layout.

The light guide plate 2 is a single layer of light guide function flaky material selected from the material group of polycarbonate (PC), polymethyl methacrylate (PMMA) and other high refractive index materials, and formed on one surface of the reflective film 1 (for example, the top surface of the first circuit layer 12) using printing, gluing, pressing, or other processing techniques. Further, mechanical drilling, punching or laser processing is employed to make a plurality of through holes 21 on the light guide plate 2 corresponding to the first electrode contacts 121. The light guide plate 2 provides a light incident area 22 that is processed to provide at least one hole 221 corresponding to conducting contacts 122.

The light-shielding film 3 is a single layer insulative film made from polycarbonate (PC), polyethylene terephthalate (PET), Mylar, or any other suitable flexible material. The light-shielding film 3 is bonded with one surface, namely, the bottom surface thereof to an opposite surface of the light guide plate 2 opposite to the reflective film 1. Further. paint-coating or printing is employed to coat the other surface, namely, the top surface of the light-shielding film 3 and the other surface, namely, the bottom surface of the reflective film 1 with a layer of high reflective white ink or high light absorbing ink to create a light-shielding layer (not shown). In actual application, the reflective film 1 can be made from a semi-transparent material (light color material), or opaque color material (dark color material. The light-shielding film 3 can be further adhered with a light-shielding adhesive (not shown). Further, the light-shielding film 3 provides a light transmissive area corresponding to the through holes 21. Further, printing, etching and electroplating manufacturing processes are employed to create a second circuit layer 31 on an inner surface, namely, the bottom surface of the light-shielding film 3 that faces toward the light guide plate 2. The second circuit layer 31 exhibits a symmetric relationship with the first circuit layer 12. The second circuit layer 31 has a circuit layout thereon, and a plurality of second electrode contacts 311 arranged on the circuit layout corresponding to the through holes 21 of the light guide plate 2 and the first electrode contacts 121 of the first circuit layer 12.

The light source 4 is disposed adjacent to the light guide plate 2, comprising at least one side emission type or top emission type light-emitting element 41 (for example, light-emitting diode) adapted for emitting light toward an incident surface of the light guide plate 2. Further, the at least one light-emitting element 41 is electrically bonded to the at least one set of positive and negative conducting contacts 122 on the first circuit layer 12 of the reflective film 1 using surface mount technology (SMT). After installation, the at least one light-emitting element 41 is respectively inserted into the at least one hole 221 in the light incident area 22 of the light guide plate 2 so that the light guide plate 2 can effectively receive the light emitted by light-emitting element 41 and distribute the received light therein in all directions, enabling the evenly distributed light to be guided out of a light exit surface thereof (not shown) toward the outside. Subject to the functioning of the internal microstructures and variously configured diffusing points (not shown) in the light guide plate 2, incident light is evenly distributed and well guided out of the light exit surface of light guide plate 2, providing enhanced lighting uniformity and brightness.

Further, in the first embodiment of the present invention, the bottom layer of the membrane switch, i.e., the first electrode contacts 121 and at least one set of positive and negative conducting contacts 122 and power contact of the first circuit layer 12 are created on the surface of the reflective layer 11 of the reflective film 1, and the at least one light-emitting element 41 of the light source 4 is electrically bonded to the at least one set of positive and negative conducting contacts 122 on the first circuit layer 12 of the reflective film 1 using surface mount technology (SMT). In actual application, the bottom layer of the membrane switch and the LED circuit of the at least one light-emitting element 41 of the light source 4 can be made on the same surface of the first circuit layer 12 according to customer's specification or requirements. Alternatively, the the bottom layer of the membrane switch and the LED circuit of the at least one light-emitting element 41 of the light source 4 can be respectively made on the two opposite surfaces (the opposing top and bottom surfaces) of the reflective film 1. Further, the light guide plate 2 is set between the reflective film 1 and the light-shielding film 3 for conducting and guiding light. Further, the through holes 21 of the light guide plate 2 are used as a spacer layer to create vertical spacing between the first electrode contacts 121 of the first circuit layer 12 of the bottom layer of the membrane switch and the second electrode contacts 311 of the second circuit layer 31 of the top layer of the membrane switch. Further, a power circuit can be integrated into the first circuit layer 12 for connection to an external power source.

The backlight module with membrane switch function in accordance with the first embodiment of the present invention can be assembled with a key switch structure 5 to create a backlit keyboard. The key switch structure 5 comprises a bottom plate 51, a plurality of key switch units 52 and a plurality of rubber cones 53. The bottom plate 51 is attached to the bottom surface of the reflective film 1 opposite to the light guide plate 2, comprising a plurality of mating connection portions 511. Each mating connection portion 511 comprises at least one upright retaining lug 5111. The upright retaining lugs 5111 are respectively upwardly inserted through respective mounting through holes 13 of the reflective film 1, respective mounting through holes 23 of the light guide plate 2 and respective mounting through holes 32 of the light-shielding film 3. Further, the key switch units 52 are mounted on the top surface of the light-shielding film 3 opposite to the light guide plate 2, each comprising a key cap 521 spaced above the light-shielding film 3 and a linking mechanism 522 coupled between the key cap 521 and the bottom plate 51 for enabling the key cap 521 to be alternatively moved up and down. The linking mechanism 522 can be a scissors mechanism or butterfly mechanism. The linking mechanism 522 has top and bottom pivots thereof (not shown) respectively pivotally coupled to the upright retaining lugs 5111 of the mating connection portions 511 of the bottom plate 51 and respective mating connection portions (not shown) of the key cap 521. The at least one elastic member 53 is mounted between the key switch units 52 and the light-shielding film 3. Preferably, the elastic members 53 support the respective key caps 521 above the light-shielding film 3. The elastic member 53 is elastically compressed to store elastic potential energy when the respective key cap 521 is pressed by an external force. When the external force disappears, the elastic member 53 immediately pushes the respective key cap 521 back to its previous position. Further, the number of the key switch units 52 and elastic members 53 of the key switch structure 5 can be adjusted to mate with the configuration of the backlight module.

When a user presses the key cap 521 of one key switch unit 52 of the key switch structure 5, the linking mechanism 522 is lowered to compress the respective elastic member 53 against a corresponding part of the second circuit layer 31 of the light-shielding film 3, forcing the corresponding part of the second circuit layer 31 into the inside of the respective through hole 21 of the light guide plate 2 and achieving electric contact between the respective second electrode contacts 311 of the second circuit layer 31 of the light-shielding film 3 of the top layer of the membrane switch and the respective first electrode contacts 121 of the first circuit layer 12 of the reflective film 1 of the bottom layer of the membrane switch. Thus, when the key cap 521 of one key switch unit 52 of the key switch structure 5, a respective signal is triggered by the key switch unit 52 and provided to the controller (not shown) of the backlit keyboard. On the contrary, when the user releases the pressure from the key cap 521 of the key switch unit 52, the respective elastic member 53 immediately returns to its former shape to push the associated key cap 521 and the associated linking mechanism 522 upwardly to their previous position, and at the same time, the light-shielding film 3 immediately returns to its previous shape to move the compressed part of the second circuit layer 31 out of the respective through hole 21 of the light guide plate 2, achieving electrical separation between the second circuit layer 31 of the light-shielding film 3 and the first circuit layer 12 of the reflective film 1 and completing one switch operating stroke. Further, when the light source 4 is electrically conducted, the at least one light-emitting element 41 is driven to emit light toward the through holes 21 in the light incident area 22, enabling emitted light to be evenly distributed on the light guide plate 2 and guided by the light guide plate 2 and reflected by the reflective layer 11 of the reflective film 1 through the light exit surface of the light guide plate 2 toward the light transmissive area of the light-shielding film 3 to illuminate the key switch unit 52 of the key switch structure 5, achieving optimized keyboard backlighting.

As described above, the invention has the first circuit layer 12 of the bottom layer of the membrane switch and the LED power circuit of the at least one light-emitting element 41 of the light source 4 mounted on the reflective layer 11 of the reflective film 1 to mate with the stacked arrangement of the light guide plate 2 and light-shielding film 3 on the top surface of the reflective film 1, and the second circuit layer 31 of the top layer of the membrane switch mounted on the inner surface (bottom surface) of the light guide plate 2 opposite to the light-shielding film 3. In addition to the function of distributing and guiding incident light, the light guide plate 2 uses the through holes 21 to work as a spacer layer that provides electrical isolation between the first circuit layer 12 and the second circuit layer 31. The through holes 21 also provide a space for the displacement stroke of the light-shielding film 3 when the light-shielding film 3 is pressed by an external force and elastically deformed. The structural design of the reflective film 1 eliminates the use of a reflector seen in the prior art backlight modules, and allows the bottom circuit layer of the membrane switch to be directly made on the reflective film 1. Further, because the LED power circuit of the at least one light-emitting element 41 of the light source 4 is integrated into the first circuit layer 12, no any additional flexible circuit board is required for the installation of the at least one light-emitting element 41 of the light source 4, and thus, the number of layers of the backlight module can be minimized, simplifying the structure, significantly reducing the module thickness for low profile application, effectively shortening the assembly process and reducing the manufacturing cost. Further, because the number of through holes on the reflective film 1 is minimized, the available surface area of the first circuit layer 12 for utilization is maximized. Further, the mounting location of the at least one light-emitting element 41 of the light source 4 on the reflective film 1 can be changed to meet different application requirements without space limitations. Further the amount of the at least one light-emitting element 41 can be changed subject to the dimension or amount of the light guide plate 2, enhancing the uniform luminous effects of the backlight module.

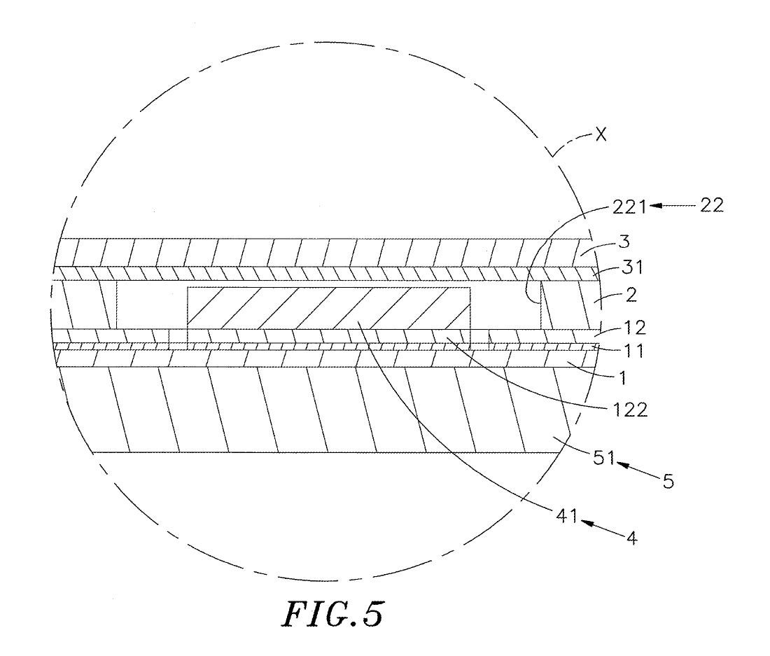

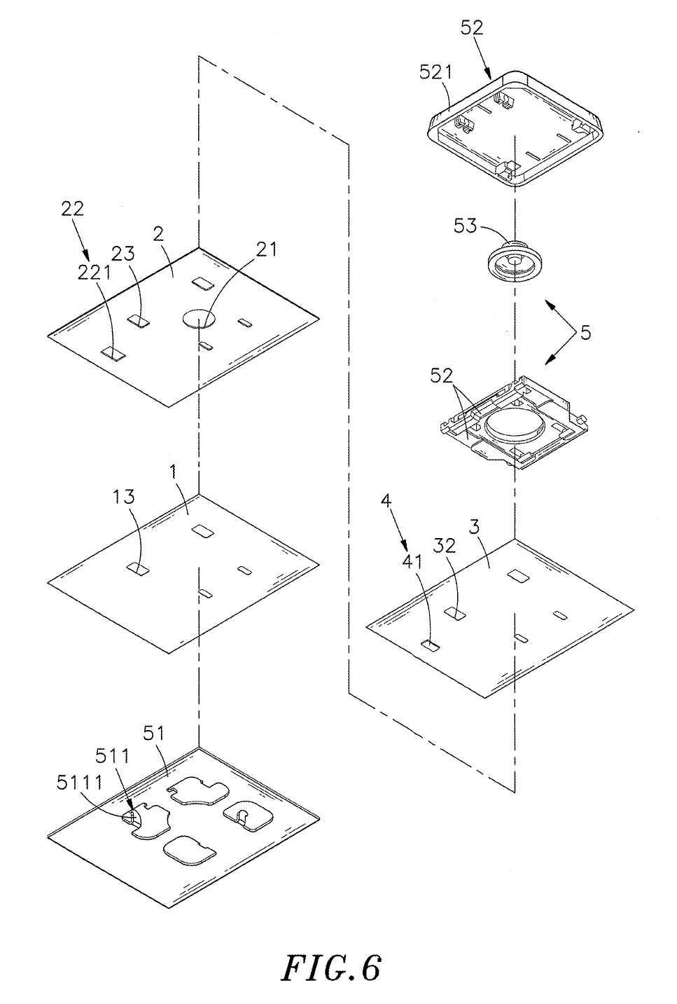

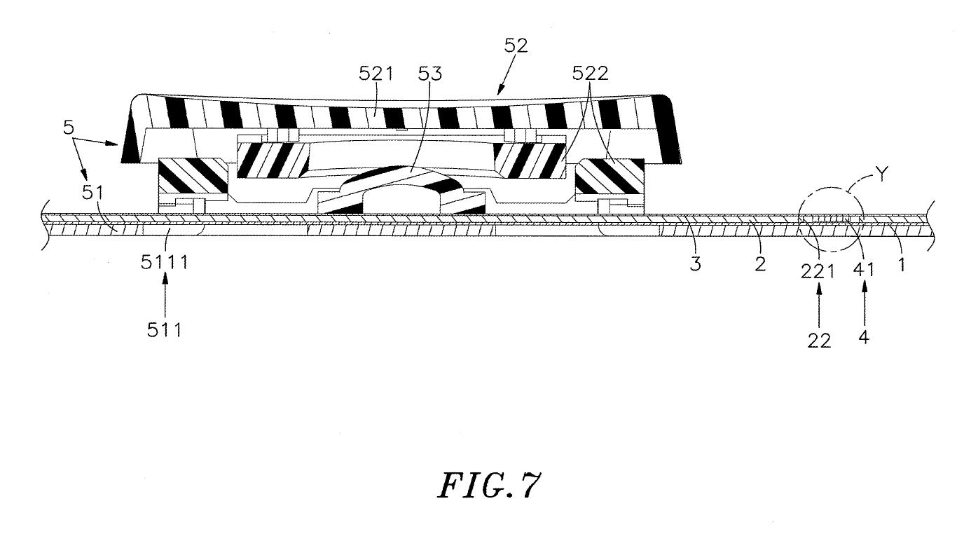

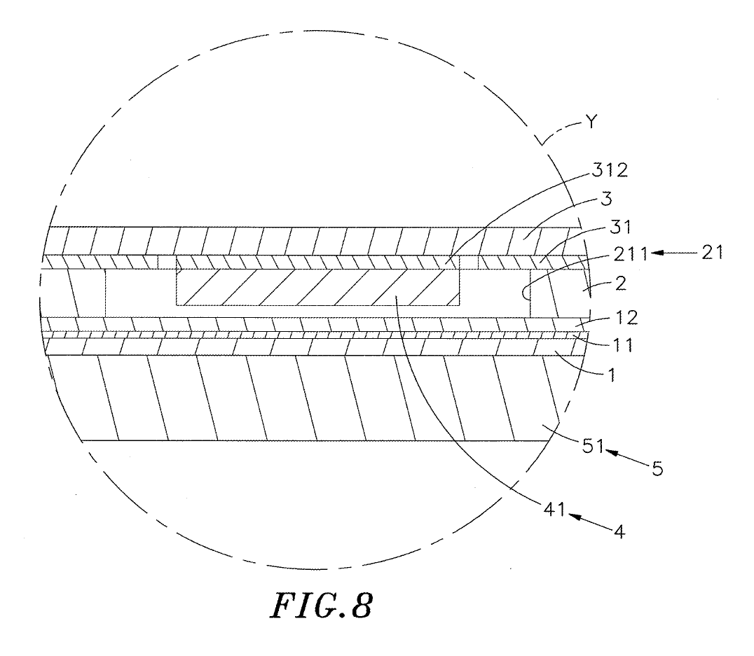

Referring to FIGS. 6-8, a backlight module with membrane switch function in accordance with a second embodiment of the present invention is shown. This second embodiment is substantially similar to the aforesaid first embodiment with the exceptions outlined hereinafter. The first circuit layer 12 of the reflective film 1 comprises a plurality of first electrode contacts 121 and at least one set of conducting contacts 122 (similar to that shown in FIG. 5); the at least one light-emitting element 41 of the light source 4 is electrically connected to the conducting contacts 122. In actual application, the second circuit layer 31 of the light-shielding film 3 can be configured to provide a plurality of second electrode contacts 311 and at least one set of conducting contacts 312 (see FIG. 8); the at least one light-emitting element 41 of the light source 4 can be electrically connected to the conducting contact 122 and controlled to emit light toward the light incident area 22 of the light guide plate 2; the second circuit layer 31 can also be configured to provide a power circuit with power contacts (not shown) for connection to an external power sourced.

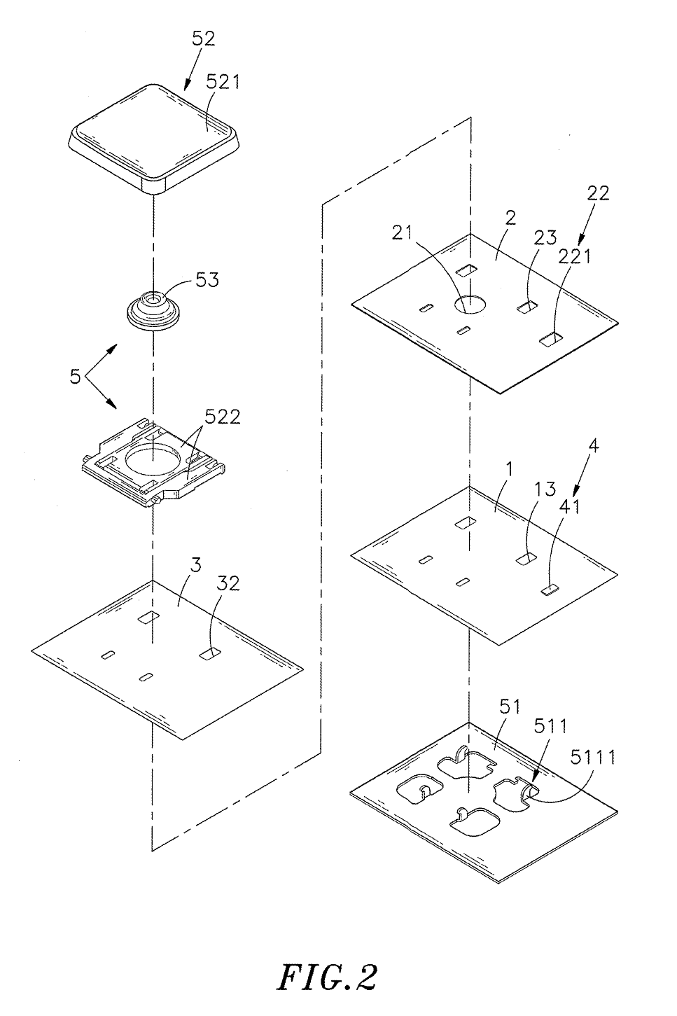

Referring to FIGS. 2, 3, 4, 6 and 8 again, the backlight module of the present invention has the first circuit layer 12 of the bottom layer of the membrane switch mounted on the reflective layer 11 of the reflective film 1, the light guide plate 2 and the light-shielding film 3 stacked up on the top surface of the first circuit layer 12, the second circuit layer 31 of the top layer of the membrane switch mounted on the bottom surface of the light-shielding film 3 in a symmetric relationship with the first circuit layer 12, and the at least one light-emitting element 41 of the light source 4 arranged to emit light toward the light incident area 22 of the light guide plate 2 so that the light guide plate 2 is not only adapted for distributing and guiding incident light but also used as a spacer layer to create vertical spacing between the first electrode contacts 121 of the first circuit layer 12 of the bottom layer of the membrane switch and the second electrode contacts 311 of the second circuit layer 31 of the top layer of the membrane switch.

The structural design of the reflective film 1 eliminates the use of a reflector seen in the prior art backlight modules, and allows the bottom circuit layer of the membrane switch to be directly made on the reflective film 1. Further, because the LED power circuit of the at least one light-emitting element 41 of the light source 4 is integrated into the first circuit layer 12, the number of layers of the backlight module can be minimized, simplifying the structure, significantly reducing the module thickness for low profile application, effectively shortening the assembly process and reducing the manufacturing cost. Further, because the number of through holes on the reflective film 1 is minimized, the available surface area of the first circuit layer 12 for utilization is maximized. Further, the mounting location of the at least one light-emitting element 41 of the light source 4 on the reflective film 1 can be changed to meet different application requirements without space limitations. Further the amount of the at least one light-emitting element 41 can be changed subject to the dimension or amount of the light guide plate 2, enhancing the uniform luminous effects of the backlight module.

Although particular embodiments of the invention have been described in detail for purposes of illustration, various modifications and enhancements may be made without departing from the spirit and scope of the invention. Accordingly, the invention is not to be limited except as by the appended claims.

1. A backlight module, comprising:
a reflective film comprising a reflective layer located on a top surface thereof;
a light guide plate located on a top surface of said reflective film, said light guide plate defining a light incident area;
a light-shielding film located on a top surface of said light guide plate opposite to said reflective film;
a membrane switch structure comprising a first circuit layer mounted on said reflective layer between said light guide plate and said reflective film and a second circuit layer mounted on a bottom surface of said light-shielding film to face toward said light guide plate, said first circuit layer and said second circuit layer being arranged to exhibit a symmetric relationship; and
a light source disposed adjacent to said light guide plate and between the first circuit layer and the second circuit layer, said light source comprising at least one light-emitting element adapted for emitting light toward said light incident area of said light guide plate.

2. The backlight module as claimed in claim 1, wherein said reflective film is a single layer insulative film selectively made from polycarbonate (PC), polyethylene terephthalate (PET) or Mylar, having the top surface thereof coated with a layer of white reflective coating to create said reflective layer.

3. The backlight module as claimed in claim 1, wherein said first circuit layer of said membrane switch structure comprises a plurality of first electrode contacts located on said reflective film; said light guide plate comprises a plurality of through holes respectively disposed to face toward the respective said first electrode contacts; said second circuit layer of said membrane switch structure comprises a plurality of second electrode contacts located on said light-shielding film respectively disposed to aim at said through holes of said light guide plate and said first electrode contacts of said first circuit layer.

4. The backlight module as claimed in claim 1, wherein said first circuit layer of said membrane switch structure comprises at least one set of conducting contacts located on said reflective film; said light guide plate comprises at least one hole located on said light incident area corresponding to said at least one set of conducting contacts of said first circuit layer; said at least one light-emitting element of said light source is electrically connected to said at least one set of conducting contacts and respectively inserted into said at least one hole on said light incident area of said light guide plate.

5. The backlight module as claimed in claim 1, wherein said light guide plate is a single layer of light guide function flaky material selected from the material group of polycarbonate (PC) and polymethyl methacrylate (PMMA), comprising at least one hole located on said light incident area for guiding in the light emitted by said light-emitting element of said light source.

6. The backlight module as claimed in claim 1, wherein said light guide plate is set between said reflective film and said light-shielding film to work as a spacer layer for providing electrical isolation between said first circuit layer and said second circuit layer.

7. The backlight module as claimed in claim 1, wherein said second circuit layer of said membrane switch structure comprises at least one set of conducting contacts located on said light-shielding film; said light guide plate comprises at least one hole located on said light incident area to face toward said at least one set of conducting contacts; said at least one light-emitting element of said light source is electrically connected to said at least one set of conducting contacts of said second circuit layer and respectively inserted into said at least one hole on said light incident area of said light guide plate.

8. The backlight module as claimed in claim 1, wherein said at least one light-emitting element of said light source is selected from the group of side emission type light-emitting diodes and top emission type light-emitting diodes.

9. The backlight module as claimed in claim 1, further comprising a key switch structure, wherein said light guide plate is set between said reflective film and said light-shielding film to work as a spacer layer for providing electrical isolation between said first circuit layer and said second circuit layer; said key switch structure comprises a bottom plate, a plurality of key switch units mounted on said light-shielding film and at least one elastic member mounted between said key switch units and said light-shielding film, each said key switch unit comprising a key cap spaced above said light-shielding film and a linking mechanism coupled between said key cap and said bottom plate for enabling said key cap to be alternatively moved up and down so that said elastic member and said light-shielding film are elastically deformed to force said second circuit layer into contact with said first circuit layer to conduct electricity when said key cap is pressed by an external force to move said linking mechanism.

10. The backlight module as claimed in claim 9, wherein said reflective film is a single layer insulative film selectively made from polycarbonate (PC), polyethylene terephthalate (PET) or Mylar, having the top surface thereof coated with a layer of white reflective coating to create said reflective layer.

11. The backlight module as claimed in claim 9, wherein said first circuit layer of said membrane switch structure comprises a plurality of first electrode contacts located on said reflective film; said light guide plate comprises a plurality of through holes respectively disposed to face toward the respective said first electrode contacts; said second circuit layer of said membrane switch structure comprises a plurality of second electrode contacts located on said light-shielding film respectively disposed to aim at said through holes of said light guide plate and said first electrode contacts of said first circuit layer.

12. The backlight module as claimed in claim 9, wherein said first circuit layer of said membrane switch structure comprises at least one set of conducting contacts located on said reflective film; said light guide plate comprises at least one hole located on said light incident area corresponding to said at least one set of conducting contacts of said first circuit layer; said at least one light-emitting element of said light source is electrically connected to said at least one set of conducting contacts and respectively inserted into said at least one hole on said light incident area of said light guide plate.

13. The backlight module as claimed in claim 9, wherein said light guide plate is a single layer of light guide function flaky material selected from the material group of polycarbonate (PC) and polymethyl methacrylate (PMMA), comprising at least one hole located on said light incident area for guiding in the light emitted by said light-emitting element of said light source.

14. The backlight module as claimed in claim 9, wherein said second circuit layer of said membrane switch structure comprises at least one set of conducting contacts located on said light-shielding film; said light guide plate comprises at least one hole located on said light incident area to face toward said at least one set of conducting contacts; said at least one light-emitting element of said light source is electrically connected to said at least one set of conducting contacts of said second circuit layer and respectively inserted into said at least one hole on said light incident area of said light guide plate.

15. The backlight module as claimed in claim 9, wherein said at least one light-emitting element of said light source is selected from the group of side emission type light-emitting diodes and top emission type light-emitting diodes.

16. The backlight module as claimed in claim 9, wherein said bottom plate of said key switch structure is attached to a bottom surface of said reflective film, comprising a plurality of mating connection portions upwardly inserted through said reflective film, said light guide plate and said light-shielding film in a proper order and pivotally coupled with said linking mechanisms of said key switch units.
